(19) United States
(12) Patent Application Publication
(10) Pub. No.: US 2019/0195562 A1
(43) Pub. Date: Jun. 27, 2019

(54) METHOD AND APPARATUS FOR OPTIMIZING A BAKING PROCESS

(71) Applicant: MIWE Michael Wenz GmbH, Arnstein (DE)

(72) Inventors: Adrian Issing, Wuerzburg (DE); Christoph Weigel, Stepfershausen (DE); Uwe Klatt, Kuernach (DE); Ronny Leppich-Rudloff, Karlstadt (DE); Steven Schmidt, Massbach (DE); Stephan Seipp, Hofheim am Taunus (DE)

(73) Assignee: MIWE Michael Wenz GmbH, Arnstein (DE)

(21) Appl. No.: 16/225,119

(22) Filed: Dec. 19, 2018

(30) Foreign Application Priority Data
Dec. 21, 2017 (DE) 102017131036.3

(51) Int. Cl. F27D 21/02; A21D 8/06; A21B 3/10; A21B 3/13; F27D 21/04

(52) U.S. Cl. CPC F27D 21/02; A21D 8/06; F27D 2021/026; A21B 3/135; F27D 21/04; A21B 3/10

(57) ABSTRACT

A baking process includes placing a baked goods carrier onto a work surface and filling the baked goods carrier with pieces of dough. Display data may be transmitted using a computer to a digitally controlled display apparatus close to the work surface for displaying a desired filling. The actual filling may be captured by an image recording apparatus and transmitted to the computer. The captured data of the actual filling may be evaluated using the computer and compared to data relating to the desired filling. The computer may be used to act on the filling process and/or the baking process.

### TECHNICAL FIELD

The system described herein relates to a method and an apparatus for optimizing a baking process, in particular in commercial baking facilities such as bakeries, baked goods factories and showrooms with baking ovens.

### BACKGROUND OF THE INVENTION

In commercial baking facilities, in particular in food retail showrooms having baking ovens, preparation tables are used to prepare pieces of dough for treatment in the baking oven. Baked goods carriers, usually baking trays, are placed on work surfaces, for example stainless steel surfaces, of the preparation tables which are suitable for food processing and are filled with pieces of dough by trained personnel. This filling process is carried out by trained professionals in craft bakeries. In contrast, in food retail, it is often carried out by quickly trained sales personnel without special knowledge in the field of baking. In order to nevertheless fill the baked goods carriers in a largely correct manner, filling plans are arranged close to the work surfaces of the preparation tables, from which the personnel can gather the correct filling with different pieces of dough. However, working according to the filling plans also requires a considerable amount of experience and skill in order to correctly understand and implement the information on the filling plans.

The document EP 2 106 700 B1 discloses a baking system in a supermarket, in which a display/input apparatus is provided at a loading point and can be used in two ways. Either an operator reads the type of baked goods to be loaded from the display of the display/input apparatus and accordingly loads carrier elements for the baked goods, or the operator loads the carrier elements according to his selection and indicates the corresponding information relating to the type or quantity of baked goods which have been loaded to the controller of the baking system via the display/input apparatus.

### SUMMARY OF THE INVENTION

It is desirable to improve (e.g., optimize) the preparation process of the baking process and possibly also to improve the baking process itself.

In some embodiments of the system described herein, provided is a method for improving (e.g., optimizing) a baking process. The method may include placing a baked goods carrier onto a work surface; and filling the baked goods carrier with pieces of dough. The method additionally may include the following steps:
transmitting display data, by means of a computer, to a digitally controlled display apparatus close to the work surface for displaying desired filling;
capturing the actual filling by means of an image recording apparatus and transmitting the captured data to the computer;
evaluating the captured data by means of the computer and comparing them with the data relating to the desired filling; and
acting on the filling process and/or the baking process by means of the computer.

The filling plan may be displayed by means of a digitally controllable display apparatus, for example a screen or a projector. Therefore, not only may a controller transmit information relating to the type and quantity of baked goods to the operating personnel, as in EP 2 106 700 B1, but rather the exact filling plan having the positions and orientations of the baked goods may be displayed to the operating personnel. The screen may hang above the work surface. However, it also may be arranged under the work surface if the work surface is transparent and is composed of glass, for example. In this case, the baked goods carrier may be placed directly beside the display on the screen, with the result that the specifications for the desired filling on the screen may be captured together with the actual filling on the baked goods carrier at a glance. Alternatively, the display apparatus may be a projector. The projection may be cast onto a screen or a bright building wall close to the work surface. However, it also may be cast onto the work surface itself. In some embodiments, the work surface may be white or a bright color and as matte as possible so that the projected representation is clearly and easily discernible.

Furthermore, in some embodiments, the actual filling is captured by an image recording apparatus and the captured data are transmitted to the computer. The capture can be carried out either at the same time as the display or in alternating fashion with the display. Such an alternating procedure may be useful, in particular, in the case of a projection onto the work surface itself so that the capture may capture pieces of dough which are actually present and not capture projected pieces of dough.

The captured data may be compared by the computer with the data relating to the desired filling. The computer may act on the filling process and/or the baking process on the basis of this comparison.

For example, the computer may be configured to prompt the output of an alarm signal in the event of incorrect filling. For this purpose, a signaling apparatus, such as a loudspeaker or a light, may be coupled to the computer and controlled to emit a signal when incorrect filling is determined. However, the alarm signal also may be emitted by the display apparatus itself. For example, a representation of the actual filling, in which the incorrect filling may be optically highlighted, may be superimposed on the desired filling displayed by the display apparatus. The incorrect filling may be represented more brightly, for example, or may be marked with a color boundary. In the case of a display directly by means of projection on the work surface, it may be particularly simple to shift the piece of dough, which may be at the location of the marked display of its positioning, in such a manner that it is at the optimum location for the baking process.

The computer also may be coupled, via an interface, to the baking oven into which the filled baked goods carrier (baking tray) is introduced for baking. On the basis of the captured actual filling, the computer may therefore transmit optimized baking parameters to the baking oven in order to act on the baking process and improve the latter. Baking ovens are usually loaded with a plurality of baked goods carriers. If these are all filled on a work surface of the type described here, baking parameters may be determined on the basis of the filling data relating to all baked goods carriers. The baking parameters may include, for example, the baking temperature, baking time, time and amount of water added to produce baking fumes.

In order to assign a particular baked goods carrier to a particular baking process, at least one capture unit may be connected to the computer, which capture unit may capture the introduction of a filled baked goods carrier into a baking oven. For example, a barcode or a QR code may be assigned to the baked goods carrier, which code may be captured by the image recording apparatus during filling and may be stored together with the data relating to the specific filling of the baked goods carrier. A capture unit which reads the barcode or QR code captures the introduction of the baked goods carrier into the baking oven. In this case, the capture unit may capture the code of the baked goods carrier directly during introduction. In this case, the capture unit may be a camera close to the oven door, for example. However, it is also possible for the baked goods carrier to be introduced into a baking trolley in an intermediate step and to then no longer be readable. Only the baking trolley or the uppermost baked goods carrier in the baking trolley then may be read at the baking oven. For this purpose, the introduction of the baked goods carrier into a baking trolley may be captured and it suffices for only the uppermost barcode on the uppermost baked goods carrier to be read at the baking oven in order to obtain the complete information relating to the filling of all baking trays in the baking trolley. An important factor is that each baked goods carrier may be tracked until it is introduced into the baking oven so that the baking parameters can be adjusted to the filling of each baked goods carrier. Other identification marks, for example RFID tags, or else optical recognition by means of image evaluation, naturally also may be used for this purpose. A capture unit also may capture the removal of the baked goods from the oven and thus may assess the quality of the baking result on the basis of optical features such as coloration of the baked goods and size of the baked goods.

In practice, the data for the desired filling and/or the baking parameters may be stored on a data storage unit coupled to the computer. Both the transmission of data from and to the computer and the transmission of data from and to the data storage unit may be carried out via the Internet. A person running a plurality of food retail stores having baking ovens therefore may operate a central computer and a central data storage unit, possibly with a backup system, in order to control the displays and the image capture devices of all preparation tables having work surfaces. On the one hand, this may save costs of repeatedly setting up and maintaining a plurality of data processing systems. In some embodiments, only the main system and possibly the backup system may need to be set up and financed. Furthermore, the central system may process a larger number of data items, with the result that evaluation of the data and adaptation of the desired data using an algorithm having artificial intelligence may take place in a very much more reliable manner than in the case of individual decentralized computers in each store. Finally, the networked and centrally controlled data capture and data output by means of a central computer standardizes the baking results in the various sales outlets.

In order to specify the desired filling and to capture and compare the actual filling, it is also possible for the central computer to be installed at the manufacturer of the baking ovens and to be connected to the different sales outlets or sites of the baking ovens via the Internet. In this manner, the manufacturer may collect the data from the sales outlets belonging to different customers and may use said data to improve the system.

The following display apparatuses are possible for image display:
a screen;
a projector, in particular a video projector such as an LCD projector (also called digital projector) or a laser projector;
AR glasses (augmented reality glasses).

As mentioned, the representation may be directly discerned on the work surface, in particular if a projector above the work surface is used, or else if a screen below a transparent work surface is used. The operating personnel also may wear augmented reality glasses (AR glasses—also called data glasses) which virtually project information in front of the eyes of the person wearing the glasses, while he still may see the outside world. Such data glasses are known and may include, for example, Google Glass or Microsoft HoloLens.

The image recording apparatus may be the following, for example:
a two-dimensional monochrome camera;
a two-dimensional color camera;
a stereoscopic camera, that is to say a 3-D camera (either monochromatic or in color);
a time-of-flight (ToF) camera (monochromatic or in color); or
a laser scanner.

A laser scanner captures a three-dimensional image and individually scans the pixels. Both a stereoscopic camera (camera having two objectives which produces two images) and a time-of-flight camera, which also captures the time of flight of the light at the same time as the brightness or color of the pixels, produce a three-dimensional representation with each image in the case of simultaneous capture of all pixels.

The computer analyzes the image data and may take any of the following data into account:
type of baked goods;
quantity of baked goods;
orientation of the baked goods;
state of the baking tray (present, not present, damaged, soiled, correct type of baking tray (color, coating), baking paper present);
distances between the baked goods; and
distances between the baked goods and the edge of the tray.

The computer also may calculate the requirement for baked goods or may determine it on the basis of empirical values which it has obtained over its operating time. Furthermore, the computer may capture the number of baked goods produced and the number of baked goods consumed or sold and may calculate the requirement for baked goods therefrom. The computer therefore may calculate flexible optimum filling patterns for the different baking trays on the basis of the calculated or determined requirement for different baked goods and may individually display said patterns for each filling process on the preparation table. As a result of an error signal in the event of a deviation from the specified filling, the computer may improve the filling process. The computer may use the required baked goods to calculate the complete baking orders, that is to say the desired filling of all baked goods carriers which are to be introduced into the baking oven for a baking process. In this case, the computer considers which baked goods may be optimally baked together (for example Kaiser rolls and split rolls). The computer usefully groups the baked goods on a baking tray and groups the different baking trays for a baking process. In this case, the computer also may capture, by means of the image recording apparatus, the actual filling of each individual baked goods carrier which may be introduced into the oven for a baking process, including all possible instances of incorrect filling, and—as mentioned above—may calculate the optimum baking parameters therefrom, for example the baking time and baking temperature, and may transmit them to the baking oven.

The software for controlling the filling and the parameters determined and specified thereby may be improved (e.g., optimized) by means of optimization algorithms according to artificial intelligence methods. The results and sequences of the baking processes may be recorded in this case by means of manual input or automatic monitoring, for example by means of image capture, and may be used to improve the parameters. At least one of the following parameters may be improved:
the baking parameters;
the evaluation of the image data;
the desired filling of the baked goods carriers; and
the grouping of the baked goods which are combined with one another on a baking tray and/or during a baking process.

In this case, it may be advantageous if the computer monitors and controls as many baking processes as possible at as many baking stations as possible. It also may be useful if either an image recording apparatus and/or the personnel operating the baking oven transmit(s) information relating to the baking result to the computer. Information such as brightness and color may be captured most easily using an image recording apparatus. The same image recording apparatus as for observing the filling process or else another image recording apparatus may be used for this purpose.

An apparatus for optimizing a baking process may have a work surface for the placement of a baked goods carrier. One or more of the following features additionally may be present:
a digitally controlled display apparatus close to the work surface for displaying desired filling;
a computer for transmitting display data to the display apparatus; and
an image recording apparatus for capturing the actual filling, which apparatus may be coupled to the computer for the purpose of transmitting the captured data.

A computer program product for evaluating the captured data and for comparing them with the data relating to the desired filling and for acting on the filling process and/or the baking process may run on the processor of the computer. In particular, the results of the program product may be improved according to artificial intelligence methods. A signaling apparatus may be coupled to the computer. The computer may be coupled to a baking oven via a data interface. At least one data storage unit may be coupled to the computer. The computer may be connected to the Internet for the purpose of transmitting data. As a result, the method may be implemented at different locations by means of a computer which has been centrally set up and communicates with the devices at the different locations via the Internet.

### BRIEF DESCRIPTION OF THE DRAWINGS

Further practical embodiments and advantages of the system described herein are described below in connection with the drawings:

FIG. 1 shows a three-dimensional illustration of a first embodiment of a preparation table according to the system described herein;

FIG. 2 shows a second embodiment of a preparation table in a three-dimensional illustration;

FIG. 3 shows a third embodiment of a preparation table in combination with a baking oven; and

FIG. 4 shows a displayed representation which may be used in the method according to embodiments of the system described herein.

### DESCRIPTION OF THE VARIOUS EMBODIMENTS

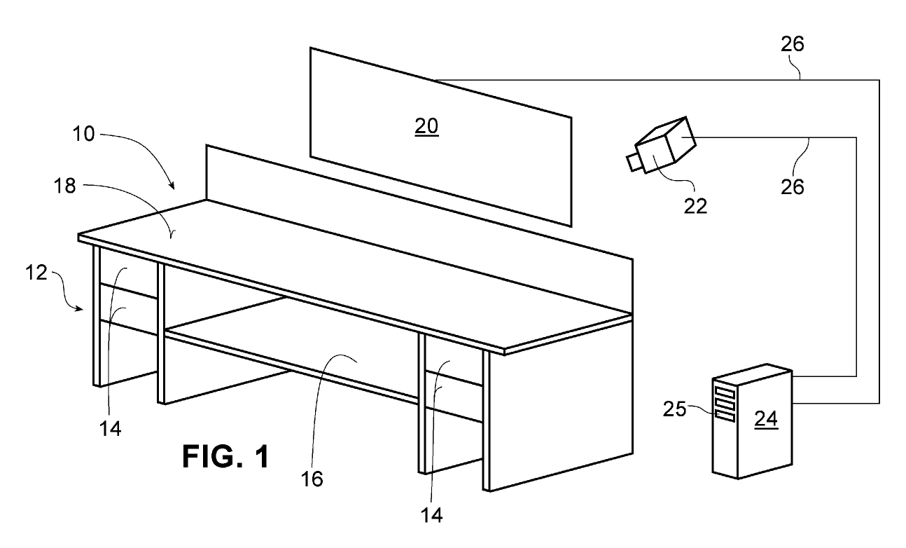

A preparation table 10 having a table frame 12 can be seen in FIG. 1. The table frame 12 has drawers 14 on the sides and a storage compartment 16 in the center. The work surface 18 of the preparation table 10 may be composed of a material suitable for food processing, for example stainless steel.

According to the system described herein, a display apparatus, a flat LCD screen 20 in the present case, may be arranged above the work surface 18. The screen 20 may be usefully arranged on a wall (not illustrated) of the work area in which the preparation table 10 is situated. An image recording apparatus 22 may be likewise arranged on a wall or ceiling (not illustrated) of the work area. The image recording apparatus 22 may be directed to the work surface 18. The image recording apparatus 22 may be a conventional camera, a 3-D camera which operates in the stereoscopic method, a laser scanner or a ToF camera (likewise a 3-D camera). The image recording apparatus 22 may capture baking trays which are arranged on the work surface 18 and are filled with pieces of dough for baking. This process is described further below.

The image recording apparatus 22 and the screen 20, which forms the display apparatus, may be connected to a computer 24 via data lines 26. The computer 24 may evaluate the images recorded by the image recording apparatus 22 and compare the data determined therefrom with desired values. In particular, the pieces of dough which have been placed on the trays and can be identified by means of a shape comparison may be captured. The distance which must exist between one piece of dough and the adjacent piece of dough or the edge of the baking tray may be determined on the basis of the detected pieces of dough.

The computer 24 may specify the filling of a baking tray, that is to say the type and number and position of the pieces of dough to be placed on the tray. This may be carried out, for example, on the basis of a manual input of the baked goods to be produced. The operating personnel may specify the respective number of different baked goods to be produced in a baking process via a keyboard or another input apparatus (or else via voice input), for example. The computer 24 then may use the number and type of baked goods required to determine the optimum position of the baked goods on the baking tray(s) if the baking oven is designed to bake a plurality of baking trays arranged above one another. However, the computer 24 also may be coupled to a cash register system, with the result that it may be provided with information relating to how many baked goods of a particular type are sold in a particular period. The computer 24 may use the captured sales figure and sales speed of each type of baked goods to calculate how many baked goods of each type should be baked again. The coupling of a cash register system to a data processing unit for the purpose of determining the required number of baked goods is described in detail in the document DE 10 2005 016 769 B4 by the applicant. In said document, an automatic baking apparatus is controlled using the determined requirement numbers for the different baked goods. In the present case, the determined requirement for baked goods may be used to calculate the optimum filling of the baked goods carriers (baking trays) and to display it to the operating personnel filling the baked goods carrier via the display apparatus, namely the screen 20.

If the filling of a baked goods carrier captured by the camera 22 deviates from the specified desired filling, a signal may be output. For example, the screen 20 may be provided with a loudspeaker which outputs a signal tone. Alternatively, an optical signal may be emitted either by means of a representation on the screen 20 or by means of an additional warning lamp (not illustrated). Alternatively or additionally, the incorrectly positioned piece of dough may be displayed on the screen 20 and highlighted in color. At the same time, the desired position may be displayed on the screen 20, with the result that the operating personnel may correct the incorrect positioning of the piece of dough.

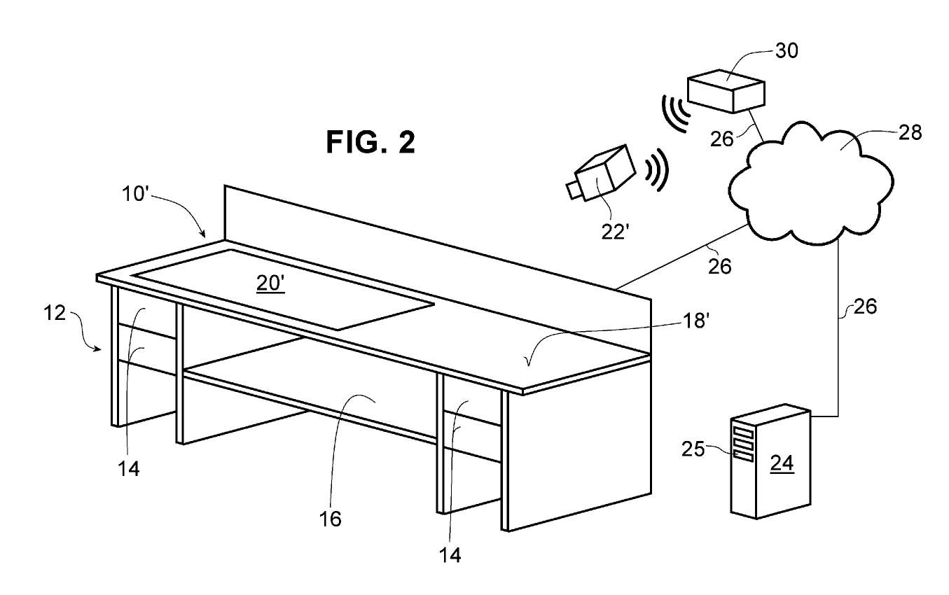

FIG. 2 shows an alternative embodiment of a preparation table 10′. In this case, the display apparatus, namely the screen 20′, is arranged under the work surface 18′. In the present case, the work surface 18′ is transparent and is composed of glass, for example. Since the baked goods carriers/baking trays also may be placed onto the work surface 18′, the screen 20′ may have been shifted to the left. The baked goods carriers may be placed onto the right-hand section of the work surface 18′ for filling.

FIG. 2 schematically illustrates that the components interacting with one another may be connected to one another via the Internet 28. The computer 24 and the screen 20′ in the preparation table 10′ are again connected via data lines 26. The image recording apparatus 22 may have a WLAN module which communicates with a WLAN router 30 which may be connected to the Internet 28.

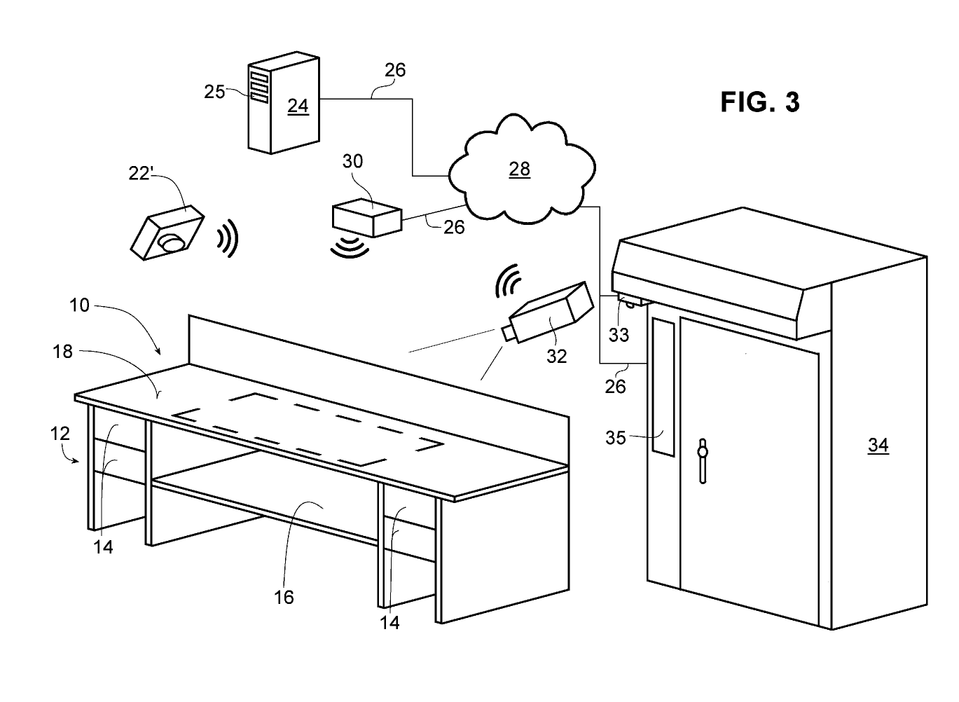

In the embodiment in FIG. 3, the work table 10 is again free from a display apparatus. In this case, the display apparatus is formed by a projector 32 which may be an LCD projector or a laser projector, for example. In this embodiment, the image recording apparatus 22′ is arranged on the opposite side of the preparation table 10. However, it also may be on the same side or else may be mounted together with the projector 32 in a housing. Both the projector 32, which forms the display apparatus, and the image recording apparatus 22′ communicate with the Internet 28 via a WLAN router 30. However, it is apparent to a person skilled in the art that the data connection to the Internet 28 may have any desired configuration. Radio communication standards other than WLAN (for example Bluetooth) may be used. Mobile data communication standards such as LTE or UMTS also may be used. Finally, all devices may be connected to the Internet 28 via data lines 26. In FIG. 3, the computer 24 and a baking oven 34 may be connected to the Internet 28 via data lines 26. The baking oven 34 may have a control module 35 which has a data interface for connecting the data line 26. A capture unit 33 may be arranged on the baking oven 34 and may be likewise connected to the Internet 28 via a data line 26. The capture unit 33 may be a camera which captures barcodes on the baked goods carriers and/or on baking trolleys on which the baked goods carriers are transported into the baking oven 34. Further capture units may be arranged in the premises in which the filled baked goods carriers are handled so that each baked goods carrier may be completely tracked until it is introduced into the baking oven. If appropriate, the correct arrangement of baked goods carriers in the baking trolley also may be displayed by means of further output units or displays, with the result that the real-time display of the filling information relating to the baked goods carriers may be combined with the real-time display of the loading information for the baking trolley. This excludes baked goods which require different baking programs being arranged on a baking trolley.

If the capture unit 33 is in the form of a camera, it also may capture image data from the finished baked goods upon removal from the baking oven and may transmit them to the computer. These image data may be used to improve the baking parameters and the filling of the different baked goods carriers.

It is obvious to a person skilled in the art that a data network other than the Internet 28 may be used. If all devices are arranged inside one building, a local area computer network (LAN) may be used. However, since the Internet 28 is the most widespread of all data networks, it may be sensible to use the Internet 28 for the required transmission of data. Each device also may be coupled to the data network using a data connection other than that illustrated.

The baking oven 34 in FIG. 3 may be situated in the same room as the preparation table 10 or in an adjacent room. The computer 24 may be at a great distance from the preparation table 10 and also from the baking oven 34. For example, a central computer 24 may control the preparation tables 10 and/or baking ovens 34 in a plurality of sales outlets in different cities or countries. The computer 24 may be operated, for example, by the head office of a chain of sales outlets.

It also may be possible for the computer 24 to be operated by the manufacturer of the baking oven 34. The manufacturer has a great deal of experience with its products and with baking technology in general. Therefore, it may be possible for the manufacturer of the baking oven 34 to select optimum programs for filling the baked goods carriers. In addition, the computer 24 may have program modules which are used for self-optimization by using artificial intelligence. The data from the image recording apparatus 22, 22′ may be used for the self-optimization. It also may be possible to arrange further image recording apparatuses (not illustrated) in the vicinity of the baking oven 34, which image recording apparatuses capture the baking result and assess the baking quality by means of image evaluation. Alternatively or additionally, the operating personnel may input information relating to the baking quality by means of an input apparatus. If the computer 24 is arranged at the head office of a sales chain, the data from all sales outlets may be taken into account. In contrast, if the computer 24 is arranged at the manufacturer of the baking oven 34, the data from all participating customers of the baking oven manufacturer may be taken into account for the optimization and the manufacturer may provide the digital filling instruction as a special service with its baking oven systems.

In the drawings, the computer 24 has an internal data storage unit 25 in the form of an installed drive. However, the data also may be stored on an external data storage unit, for example a cloud memory. The computer also may be integrated in the control module 35 of the baking oven 34. In this case, the data storage unit may be either locally likewise arranged in the control module 35 or may be arranged in a decentralized manner in the cloud or on a server belonging to the manufacturer.

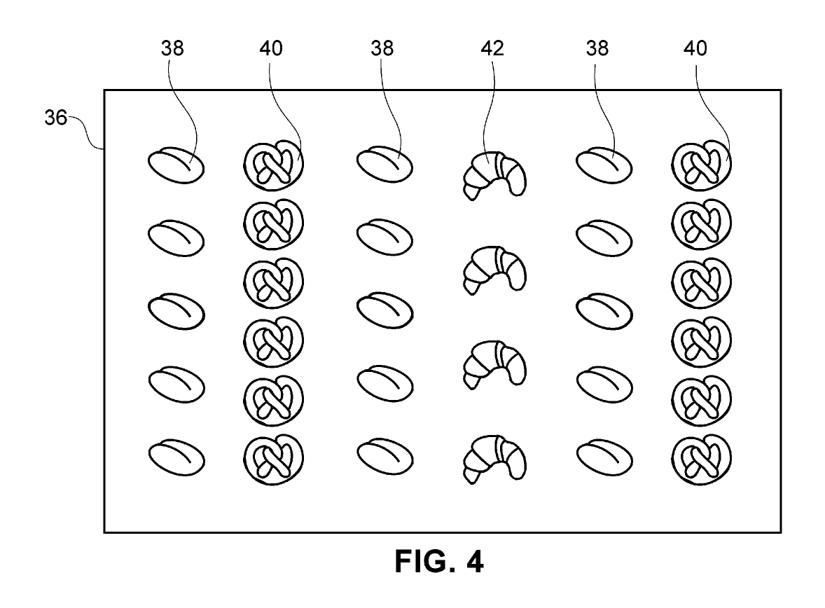

FIG. 4 shows, for example, a representation, as may be displayed by the display apparatus 20, 20′ or 32. A frame 36 defines the contours of the baked goods carrier, generally a baking tray. This frame 36 may be projected onto the work surface 18 so that the operating personnel place a baking tray in the frame 36. Alternatively, the baking tray may be arranged at any desired point on the work surface and the frame 36 may be projected onto the position of the baking tray. Schematic representations of bread rolls 38, pretzels 40 and croissants 42 may be displayed either by the projector 32 or by the screen 20, 20′ as the display apparatus. In the case of the display by the projector 32 in particular, image processing software may project the representations directly onto the position on the baking tray onto which the corresponding piece of dough is to be placed. At least one stop which defines the position of the baking tray may be provided for this purpose. The image processing software then calculates the corresponding positioning of the pieces of dough with respect to this stop. However, the baking tray also may be freely placed onto the work surface 18 and the image processing software may determine the position of the baking tray and calculate the positions of the representations of the pieces of dough on this baking tray. The operating personnel need then only place a piece of dough for a bread roll onto the corresponding bread roll representation 38, a piece of dough for a pretzel onto a pretzel representation 40 or a piece of dough for a croissant onto a croissant representation 42.

The representations 38, 40, 42 for the baked goods initially may be projected onto a baked goods carrier by a projector 32 in a green color, for example. If a piece of dough has been placed on the tray, the color of the projection may be changed to red, with the result that the operating personnel already discern solely from the color whether a piece of dough has already been placed on the tray. If a piece of dough has been placed incorrectly, in particular at incorrect positions, the desired position of the piece of dough may be displayed in a yellow color or another signal color and may flash, for example. The viewer's attention may be therefore drawn to the fact that the piece of dough is not correctly at the location intended for it.

As mentioned above, the number and type of pieces of dough to be placed on the tray may be specified by the computer 24. The computer may store, for example, empirical values which reveal the time at which what number of which baked goods should be produced. In addition, the computer may capture sales figures via a cash register system and may take them into account when requesting new baked goods. The computer may calculate optimum filling of the baked goods carriers and optimum loading of the baking oven on the basis of the currently required baked goods. Depending on the quantity of baked goods and the type of baked goods, they may be oriented on the baked goods carrier in an improved manner.

However, the computer 24 also may use the image recording apparatus 22, 22′ to capture further states, for example the state of the baking tray, whether a baking tray is actually present, whether a baking tray is damaged or soiled or whether the correct size, coating or color of the baking tray is used, or else whether baking paper is used on the baking tray.

The apparatus described above and the method described above make it possible to instruct even personnel with little experience to optimally fill baked goods carriers. In this case, not only the requirements of the baking process but also the current sales speeds and product requirements may be taken into account if the computer for controlling the filling of the baked goods carriers is coupled to a cash register system.

The features of the system described herein, in the drawings and in the claims, may be essential to the implementation of the system described herein in its various embodiments both individually and in any desired combinations. The invention is not restricted to the embodiments described. It may be varied within the scope of the claims and taking into account the knowledge of a relevant person skilled in the art.

1. A method of assisting a baking process, comprising:
placing a baked goods carrier onto a work surface (18, 18′);
filling the baked goods carrier with pieces of dough;
transmitting display data, by means of a computer, to a digitally controlled display apparatus close to the work surface for displaying desired filling;
capturing the actual filling by means of an image recording apparatus and transmitting the captured data to the computer;
evaluating the captured data by means of the computer and comparing them with the data relating to the desired filling; and
acting on the filling process and/or the baking process by means of the computer.

2. The method according to claim 1, wherein acting on the filling process comprises at least one of the following steps:
outputting an alarm signal by means of the computer in the event of an incorrect filling; and
outputting a representation of the actual filling in which the incorrect filling is optically highlighted and the desired filling is additionally represented.

3. The method according to claim 1 wherein acting on the baking process comprises the transmission of baking parameters to a baking oven via a data connection to the baking oven on the basis of the captured actual filling.

4. The method according to claim 3, wherein each baked goods carrier which has been filled is captured during introduction into the baking oven.

5. The method according to claim 1, wherein the data for the desired filling and/or the baking parameters are stored on a data storage unit coupled to the computer.

6. The method according to claim 1, wherein the data are transmitted from and to the computer and/or the data storage unit via the Internet.

7. The method according to claim 1, wherein optimization algorithms according to artificial intelligence methods optimize at least one of the following parameters:
the baking parameters;
the evaluation of the image data;
the desired filling of the baked goods carriers; and
the grouping of the baked goods which are combined with one another on a baking tray and/or during a baking process.

8. An apparatus for assisting a baking process for a work surface for the placement of a baked goods carrier, the apparatus comprising:
a digitally controlled display apparatus close to the work surface for displaying desired filling;
a computer for transmitting display data to the display apparatus;
an image recording apparatus for capturing the actual filling, which apparatus is coupled to the computer for the purpose of transmitting the captured data.

9. An apparatus according to claim 8, wherein a computer program product for evaluating the captured data and for comparing them with the data relating to the desired filling and for acting on the filling process and/or the baking process runs on the processor of the computer.

10. The apparatus according to claim 8 wherein at least one capture unit is connected to the computer and captures at least one of the following:
the introduction of at least one filled baked goods carrier into a baking oven; and
the removal of at least one filled baked goods carrier from the baking oven.

11. The apparatus according to claim 8, wherein a signaling apparatus is coupled to the computer.

12. The apparatus according to claim 8, wherein the computer is coupled to a baking oven via a data connection.

13. The apparatus according to claim 8, wherein at least one data storage unit is coupled to the computer.

14. The apparatus according to claim 8, wherein the computer is connected to the Internet for the purpose of transmitting data from and to the computer.

15. The apparatus according to claim 8, wherein the display apparatus is
a screen,
a video projector or a laser projector, and
wherein the image recording apparatus is one of:
a monochrome camera;
a color camera;
a stereoscopic camera;
a time-of-flight camera; or
a laser scanner.
